(19) United States
(12) Patent Application Publication
(10) Pub. No.: US 2015/0299482 A1
(43) Pub. Date: Oct. 22, 2015

(54) METHOD FOR MANUFACTURING A COATING COMPOSITION, COATING COMPOSITION AND ITS USE

(71) Applicant: Kemira Oyj, Helsinki (FI)

(72) Inventors: Jan-Luiken Hemmes, Bergisch Gladbach (DE); Sami Puttonen, Helsinki (FI); Kimmo Huhtala, Turku (FI); Kai Virtala, Helsinki (FI)

(21) Appl. No.: 14/443,711

(22) PCT Filed: Nov. 20, 2013
(86) PCT No.: PCT/EP2013/074243

§ 371 Date: May 19, 2015

(30) Foreign Application Priority Data
Nov. 20, 2012 (EP) 12193343.6

(51) Int. Cl. C09D 11/30; C08K 3/36

(52) U.S. Cl. CPC C09D 11/30; C08K 3/36

(57) ABSTRACT

The invention relates to a method for manufacturing a coating composition for a printing substrate. Method comprises mixing together colloidal silica particles, and an aqueous dispersion of a synthetic polymer and/or polyaluminium chloride, as well as a binder solution. The obtained mixture is used for forming a coating composition to be applied on the printing substrate comprising lignocellulosic fibres. The invention also relates to a coating composition comprising binder and a dispersed cationic component derived from synthetic polymer and colloidal silica particles.

The present invention relates to method for manufacturing a coating composition, coating composition and its use according to the preambles of the enclosed claims.

Water-based inks are popular in printing, because they are environmentally friendly. For example, flexographic printing, rotogravure and inkjet printing utilize normally water-based inks.

Flexographic printing uses a flexible relief plate, which comprises a positive mirrored master of the image to be produced. Flexographic printing is especially used for printing different types of food packages, the printing substrate being e.g. cardboard.

Rotogravure uses a gravure cylinder, onto which the image to be produced is engraved. It is used, for example, for printing of magazines and packages.

Inkjet printing is one of the digital printing methods. It is widely used in printers intended for office and home use, as well as in commercial printing. In digital printing the printed document is directly produced from an electronic data file, whereby every print may be different from each other, as no printing plates are required. In inkjet printing droplets of ink are ejected from a nozzle at high speed towards a printing sheet. Inkjet printing makes specific demands on the printing substrate, which usually is a printing sheet made of paper or board. For example, ink colour density, ink absorption, ink drying time and gamut values are important parameters that are optimised for inkjet recording sheets. Because the interest in digital printing is increasing also the demand for printing substrates suitable for high-speed inkjet printing machines may be expected to increase.

Use of water-based inks in the described printing methods may also create new problems. The water-based inks may have a high surface tension, which makes the wetting of the printing substrate more difficult. This may lead to unwanted smearing of the printed image in flexographic printing and rotogravure if the wet ink remains on the surface of the printing substrate too long.

In inkjet printing both pigment inks and dye based inks are used. Pigment based inks are not absorbed by the recording substrate but remain on the surface, while the dye inks are absorbed into the recording sheet. This difference produces differences in the obtained printed image, e.g. in colour intensity and stability. Due to the different behaviour of pigment inks and dye inks it has been hard to provide an ink jet printing sheet that would be optimal for both types of inks. Typically the properties of ink jet recording sheets are optimised either for pigment inks or dye inks.

EP 1775 141 discloses recording sheets with improved image dry time. The recording sheet has at least one surface, to which is applied a liquid composition having one or more water soluble divalent metal salts, preferably admixed with one or more starches. However, the liquid composition may easily be adsorbed into the recording sheet, which may reduce the anticipated improvements. The proposed recording sheet is more suitable for pigment inks and do not necessarily provide optimal results when dye based inks are used in the ink jet printing.

An object of the present invention is to minimise or even eliminate the disadvantages existing in the prior art.

An object is also to provide a method with which an improved coating composition for different printing methods and/or printing inks may be produced.

A still further object of the present invention is to provide a coating composition which improves the printing result of the paper or paperboard in printing, especially in ink jet printing.

These objects are attained with the invention having the characteristics presented below in the characterising parts of the independent claims.

Typical method according to the present invention for manufacturing a coating composition for use in coating of a printing substrate comprising lignocellulosic fibres, comprises at least the steps of mixing together
colloidal non-porous silica particles which have a diameter in the range of 0.5-150 nm, and
an aqueous dispersion of a synthetic polymer and/or polyaluminium chloride, as well as
a binder solution,

and using the obtained mixture for forming a coating composition.

Typical coating composition according to the present invention which is suitable for use in coating of a printing substrate, is prepared by using the method according to the present invention and it comprises binder and a dispersed, preferably cationic, component derived from synthetic polymer and/or polyaluminium chloride and colloidal silica particles.

Now it has been surprisingly found out that it is possible to obtain a coating composition, which produces unexpectedly good printing properties when it is applied on a recording or printing sheet surface, especially when water based inks are used in printing. The coating composition may be obtained simply by mixing colloidal silica particles and an aqueous dispersion of a synthetic polymer and/or polyaluminium chloride, as well as a binder solution. It is speculated, without wishing to be bound by a theory, that the colloidal silica particles form flocs when they interact with the other components of the mixture. These flocs are large enough so they are retained at the surface of the recording sheet and it is assumed that they have a high surface area, which provides suitable active surface for interaction both with pigment inks and dye inks used in printing of sheet-like printing substrates.

The coating composition is applied on at least one large surface, preferably on both large surfaces, of the sheet-like printing substrate comprising lignocellulosic fibres. The coating in the sense of the present application is understood as a surface treatment, where an infinite transparent coating or transparent treatment layer is created on the printing substrate surface.

Colloidal silica may be used in amount of 10-90 weight-%, preferably 20-90 weight-%, more preferably 25-85 weight-%, more preferably 30-80 weight-%, sometimes even 50-80 weight-%, based on and calculated from the total dry weight of colloidal silica particles, synthetic polymer and/or polyaluminium chloride and binder. According to one embodiment of the invention the colloidal silica particles have a diameter in the range of 0.5-150 nm, preferably 0.5-50 nm, more preferably 1-15 nm, even more preferably 2-7 nm, advantageously 3-5 nm. Colloidal silica is here understood as a stable aqueous suspension of amorphous non-porous silica particles. The dry solids content of the colloidal silica dispersion is typically 10-25 weight-%, preferably 15-20 weight-%. Typically individual colloidal silica particles are spherical or nearly spherical. According to one preferred embodiment of the invention anionic colloidal silica is used. Colloidal silica is prepared by starting from an alkali silicate, typically sodium silicate suspension, and allowing the silica to polymerise and form particles. Colloidal silica should not be mixed up with fumed silica, which is pyrogenically produced e.g. by combustion of silicon tetrachloride.

Colloidal silica particles and the synthetic polymer have typically opposite charges. Thus, according to one preferred embodiment of the invention the synthetic polymer is a synthetic cationic polymer, provided that the colloidal silica particles are anionic. Charge density of the synthetic cationic polymer may be ≧5 meq/g, typically 5-20 meq/g, preferably 5.5-8 meq/g, more preferably 5.5-6.5 meq/g. Charge densities are measured by using the standard method SCAN W 12:04.

According to one preferred embodiment of the invention the synthetic polymer is cationic polymer. The cationic synthetic polymer may be selected from a group comprising cationic polyacrylamide, glyoxylated polyacrylamide, polyethyleneimine, polyamines, polyvinylamine, poly-diallyldimethylammonium chloride (poly-DADMAC), copolymer of acrylamide and diallyldimethylammonium chloride (DACMAC), polyamidoamine epihalohydrin and any of their mixtures. Polyamines are here understood as copolymers of dimethylamine and epichlorohydrin.

According to one preferred embodiment the synthetic cationic polymer is cationic polyacrylamide. Cationic polyacrylamide may be obtained by copolymerizing acrylamide with a cationic monomer or methacrylamide with a cationic monomer. The cationic monomer may be selected from the group consisting methacryloyloxyethyltri methyl ammonium chloride, acryloyloxyethyltri methyl ammonium chloride, 3-(methacrylamido) propyltrimethyl ammonium chloride, 3-(acryloylamido) propyltrimethyl ammonium chloride, diallyldimethyl ammonium chloride, dimethylaminoethyl acrylate, dimethylaminoethyl methacrylate, dimethylaminopropylacrylamide, dimethylaminopropylmethacrylamide, and similar monomers. According to one preferred embodiment of the invention cationic polyacrylamide is copolymer of acrylamide or methacrylamide with (meth)acryloyloxyethyltrimethyl ammonium chloride. Cationic polyacrylamide may also contain other monomers, as long as its net charge is cationic and it has an acrylamide/methacrylamide backbone. An acrylamide or methacrylamide based polymer may also be treated after the polymerisation to render it cationic, for example, by using Hofmann or Mannich reactions.

According to one embodiment of the invention the synthetic polymer is an aqueous dispersion which may be obtained by polymerising cationic monomers within a coagulant matrix. The synthetic polymer dispersions suitable for use in the present invention are synthesised by using a controlled molecular weight cationic polyacrylamide polymerised within a coagulant matrix. The coagulant matrix has higher cationic charge than the polyacrylamide which is polymerised within it. The coagulant matrix may comprise [3-(methacryloylamino)propyl] trimethylammonium chloride (MAPTAC), polydiallyldimethylammonium chloride (poly-DADMAC), polyamine, polyyinylamine, dimethylaminoethylacrylate methyl chloride or any of their mixtures. These dispersion polymers are highly structured polymers demonstrating very little linearity. This is largely due to the inclusion of hydrophobic associative groups in the synthesis. The end result is a dispersion polymer system of high cationic charge density polymers having a low molar mass and medium cationic charge density polymers having high molecular weight. These dispersion polymers are free of volatile organic compounds (VOC's) or alkyphenol ethoxylate. The molecular weight of the dispersion polymer may be 5-7.7 million Dalton and it may have a charge density value of 3-6 meq/g.

According to one embodiment of the invention the synthetic polymer is used in amount of 5-40 weight-%, preferably 7.5-35 weight-%, more preferably 10-30 weight-%, calculated from dry weight of colloidal silica particles. The dry solids content of the used aqueous synthetic polymer dispersion is typically 20-45 weight-%, preferably 30-40 weight-%.

The synthetic polymer may have an average molecular weight >100 000 Daltons, preferably 100 000-2 000 000 Daltons, more preferably 100 000-1 000 000 Daltons, still more preferably 120 000-200 000 Daltons. The average molecular weight can be measured by using gel permeation chromatography (GPC) or intrinsic viscosity. These methods are known as such for a person skilled in the art.

According to one embodiment of the invention polyaluminium chloride may be used instead of the aqueous dispersion of the synthetic polymer. According to another embodiment of the invention it is possible to use simultaneously both polyaluminium chloride and the aqueous dispersion of the synthetic polymer.

In this application polyaluminium chloride is understood as an inorganic polymer having a general formula Alₙ(OH)ₘCl₍₃ₙ₋ₘ₎. In aqueous solution it is typically present as a highly charged aluminium complex Al₁₃O₄(OH)₂₄(H₂O)₁₂⁷⁺ or AlO₄Al₁₂(OH)₂₄(H₂O)₂₄⁷⁺. For a polyaluminium chloride the degree of neutralisation, i.e. the replacement of Cl ions with OH ions, may be expressed by using the unit basicity. The basicity of polyaluminium compound may be generally expressed by the following formula

% Basicity=100×[OH]/3[Al]

The higher the basicity, the higher the degree of neutralisation. Polyaluminium chloride may have basicity in the range of 10-70%, more preferably 10-50%, measured by using standard method EN 1302.

According to the invention the admixture for forming a coating composition comprises in addition to colloidal silica particles and aqueous dispersion of the synthetic polymer/polyaluminum chloride also a binder solution. Preferably, a pre-mixture of colloidal silica particles and the aqueous dispersion of the synthetic polymer and/or polyaluminium chloride is first formed by mixing them together, and then combining the obtained pre-mixture with the binder solution. The composition is efficiently mixed during addition of the individual components. When the components of the coating composition are added in the described order, the viscosity of the coating composition easily remains at an acceptable level during preparation.

The binder, preferably as solution, is used in amount of 5-50 weight-%, preferably 7.5-25 weight-%, more preferably 10-50 weight-%, calculated from the total dry weight of colloidal silica particles, synthetic polymer and binder.

The binder, which is suitable for use in the present invention, may be selected from a group comprising polyvinyl alcohol, latex emulsion polymers, such as styrene acrylate latex, polyvinyl acetate latex, styrene butadiene latex, polyurethane, and polyacrylamides, and any of their mixtures. According to one preferred embodiment of the invention the binder solution is a starch solution, especially cationic starch solution. Starch solution is here understood as an aqueous solution of starch that has been prepared, e.g. cooked, according to methods that are as such well-known for a person skilled in the art.

Starch, which may be used in the invention, may be any suitable native starch, such as potato, rice, corn, waxy corn, wheat, barley or tapioca starch. Starches having an amylopectin content >70%, preferably >75%, more preferably >85%, are advantageous. Preferably the starch solution comprises cationic starch, which comprises cationic groups, such as quaternized ammonium groups. Degree of substitution (DS), indicating the number of cationic groups in the starch on average per glucose unit, is typically 0.01-0.20, preferably >0.06, more preferably 0.07-0.15. When cationic starch is used, it is preferably only slightly degraded or non-degraded, and modified solely by cationisation.

However, according to another embodiment it is possible to use degraded starch that is obtained by subjecting the starch to oxidative, thermal, acidic or enzymatic degradation, thermal or enzymatic degradation being preferred. Hypochlorite, peroxide sulphate, hydrogen peroxide or their mixtures may be used as oxidising agents. Degraded starch has typically an average molecular weight (Mn) 500-10 000, which can be determined by known gel chromatography methods. The intrinsic viscosity is typically 0.05 to 0.12 dl/g, determined, for example, by known viscosimetric methods.

It is also possible to employ chemically modified starches, such as hydroxyethyl or hydroxypropyl starches and starch derivatives. Also other polysaccharides, e.g. white or yellow dextrin, may be used to replace starch wholly or partially.

According to one embodiment of the invention a water-soluble divalent metal salt, preferably an alkaline earth metal salt, may be mixed to the coating composition. Possible divalent metal salts are calcium and magnesium salts, such as calcium chloride, calcium formiate, magnesium chloride or magnesium formiate, or any of their mixtures. The divalent metal salt may be used in amount of 2-25 weight-%, preferably 5-15 weight-%, more preferably 6-12 weight-%, based on the dry solids content of the coating composition. It has been observed that the effect obtained with the divalent metal salt may be enhanced when it is added to the coating composition according to the present invention. It is assumed that the divalent salt is more effectively retained on the surface, whereby its dosage may also be decreased.

The composition may comprise also one or several conventional paper coating or surface sizing additives. Possible additives are, for example, preservatives, biocides, dispersing agents, defoaming agents, lubricants and/or hardeners.

When water-soluble divalent metal salt is used, it is possible to pre-mix the divalent metal salt, such as calcium chloride, with the colloidal silica particles. This may improve the homogeneity of the final coating composition, and the dosage of the divalent metal salt.

In the context of this application the printing substrate is in sheet form and comprises wood or lignocellulosic fibre material. The substrate may comprise fibres from hardwood trees or softwood trees or a combination of both fibres. The fibres may be obtained by any suitable pulping or refining technique normally employed in paper making, such as thermomechanical pulping (TMP), chemimechanical (CMP), chemithermomechanical pulping (CTMP), groundwood pulping, alkaline sulfate (kraft) pulping, acid sulfite pulping, and semichemical pulping. The substrate may comprise only virgin fibres or recycled fibres or a combination of both. The weight of the printing sheet substrate is 30-800 g/m², typically 30-600 g/m², more typically 50-500 g/m², preferably 60-300 g/m², more preferably 60-120 g/m², even more preferably 70-100 g/m².

The printing substrate comprises mainly the above mentioned fibres and optional mineral fillers. It is preferably free from any polymer fibres. The printing substrate is not typically cellophane film, glass plate, polymer sheet, polymer laminate or polymer film. Furthermore the printing substrate is typically free from any polymer layers applied or laminated onto it. According to one preferred embodiment of the invention the coating composition is applied directly on the surface of the untreated printing substrate comprising wood or lignocellulosic fibre material.

According to one embodiment of the invention the coating composition is used for coating of a sheet-like printing substrate for water-based inks.

According to another embodiment of the invention the coating composition is used for coating of a sheet-like printing substrate for ink jet printing.

According to yet another embodiment of the invention the coating composition is used for coating of a sheet-like printing substrate for flexogravure or rotogravure printing.

According to one embodiment of the present invention the coating composition may be applied to at least one surface of the sheet-like printing substrate in amount of 0.1-7 g/m²/side, preferably 0.2-5 g/m²/side, more preferably 0.3-3 g/m²/side. If the sheet-like printing substrate is used for ink jet printing the coating composition may be applied to at least one surface of the sheet-like printing substrate in amount of 0.1-5 g/m²/side, preferably 0.4-4 g/m²/side, more preferably 0.6-3 g/m²/side.

According to one embodiment colloidal silica, aqueous dispersion of a synthetic polymer and/or polyaluminium chloride, as well as a binder solution are first mixed together. The obtained mixture may be used directly as a final coating composition and added to the surface of a printing substrate, or additional constituents, such as divalent salt, may be added to the obtained mixture in order to obtain the final coating composition. In any case the final coating composition is applied on the surface of a printing substrate for preparing the surface for printing with both pigment inks and dye based inks, especially in ink jet printing. For example colour density values for the printing substrate are usually increased and print through is reduced.

### EXPERIMENTAL

An embodiment of the invention is further described in the following non-limiting example.

Coating compositions are prepared by using a low shear mixer. First the starch is pre-cooked, whereby a defined amount of water and starch are added in to a coating container, and the mixture is heated up to near the boiling point.

After the pre-cooking of starch the other components, i.e. aqueous dispersion of the synthetic polymer and colloidal silica particles, are added under proper shear action, which ensures thorough mixing of the components with each other. The compositions are prepared according the following Table 1. The desired solid content of the coating composition is 15-16 weight-%.

TABLE 1
Components of the different test compositions

| | | | | | | Coat |
|---|---|---|---|---|---|---|
| | Starch | Silica | Polymer | CaCl₂ | | Weight |
| Sample | (kg/t) | (kg/t) | (kg/t) | (kg/t) | Sum (kg/t) | (g/m²/side) |
| Ref. | 24.6 | 0.0 | 0.0 | 5.4 | 30.0 | 1.3 |
| Comp. A | 28.5 | 28.5 | 8.0 | 8.0 | 73.0 | 3.3 |
| Comp. B | 15.2 | 15.2 | 4.3 | 4.3 | 39.0 | 1.7 |

Recording sheet substrate is 80 g/m² wood-free base paper including both softwood and hardwood pulps and a filler. Ash content of base paper is roughly 20% and it is not hydrophobic sized. The test compositions according to Table 1 are applied to the base paper by using meter size press (Metso OptiSizer) at a speed of 500 m/min. By controlling the solid content of the composition, nip pressure, rod grooving and size press running speed, the desired pickup weight is achieved.

After the coating the paper sheet is dried and calandered. Calandering is performed as so called soft calandering at temperature 70° C. and with nip load 50 kN/m.

Samples are printed with HP Business Inkjet 2800 (dye) and HP Officejet PRO 8000 (pigment). HP Business Inket 2800 is equipped with original HP ink cartridges: HP10 (black) and HP11 (cyan, magenta, yellow). HP Officejet Pro 8000 is equipped original HP 940 ink cartridges (black, cyan, magenta, yellow).

Following parameters are studied: ink density, colour gamut and print through. Ink density is measured according standard methods ISO 5-3:1995, ISO 5-4:1995. Ink density is measured with Techkon SpectroDens-densitometer, manufactured by Techkon GmbH.

Colour gamut (or simply gamut) is total range of colours than are reproduced with given set of inks, printing device and on given paper stock. For gamut measurement certain print layout need to be printed with current ink-paper-print device combination. Minimum requirement for this print layout is to include solid colour fields of primary and secondary colours. In subtractive colour model cyan, magenta and yellow are the primary colours and red, green and blue are the secondary colours.

Spectrophotometric measurement device need to be employed for CIE L*, a,* b* -measurements (later L*, a*, b*). In this case Techkon SpectroDens—device was in use. L*, a*, b* —values are measured from solid primary and secondary color patches and a*, b* -values are used as (x, y) values for X, Y—co-ordinates. These six (x, y)—values creates an uneven planar hexagon and area inside this hexagon is described as reproducible colour area, colour gamut.

Print through is the unwanted appearance of a printed image on the reverse side of the print. It is a measured reflectance value (Y-value, C/2° uv-excluded) from the reverse side of K100% inkjet printed patch. The print-through is calculated as the on the reverse side of the print and multiplied by thousand (1000).

PT=¹⁰log (R_{R∞}/R_{RP})

where

R_{R∞}=The reflectance of the reverse side of the unprinted paper (Y-value),

R_{RP}=The reflectance of the reverse side

The results for the different coating composition are shown in Table 2.

TABLE 2
Results of the experiments.

| | Pigment Ink | | | Dye Ink | | |
|---|---|---|---|---|---|---|
| | | | Comp. | | Comp. | Comp. |
| Sample | Ref. | Comp. A | B | Ref. | A | B |
| Density | | | | | | |
| K | 2.17 | 2.27 | 2.20 | 2.40 | 2.57 | 2.48 |
| C | 1.34 | 1.44 | 1.38 | 1.20 | 1.38 | 1.34 |
| M | 1.16 | 1.24 | 1.21 | 0.87 | 0.95 | 0.92 |
| Y | 1.16 | 1.22 | 1.19 | 1.08 | 1.19 | 1.16 |
| Gamut | 8720 | 9483 | 9263 | 7554 | 9153 | 8700 |
| Print through | 47 | 38 | 40 | 65 | 49 | 51 |

It can be seen from Table 2 that the density values are higher when substrate is treated according to the invention by using Compositions A and B. Increase in density values can be seen both on dye and pigment inkjet systems. Gamut values are similar to density results, use of compositions according to the invention give clearly improved gamut values than the Reference. Print through is reduced when compositions according to the invention are used. In other words ink has lower tendency to penetrate through the paper if the inventive coating composition is used.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. Method for manufacturing a coating composition for use in coating of a printing substrate comprising lignocellulosic fibres, by mixing together
colloidal non-porous silica particles which have a diameter in the range of 0.5-150 nm, and
an aqueous dispersion of a synthetic polymer and/or polyaluminium chloride, as well as
a binder solution,
and using the obtained mixture for forming a coating composition.

2. Method according to claim 1, characterised in using colloidal silica particles, which have a diameter in the range of 0.5-50 nm, preferably 1-15 nm, more preferably 2-7 nm.

3. Method according to claim 1, characterised in using colloidal silica in amount of 20-90 weight-%, preferably 25-85 weight-%, more preferably 30-80 weight-%, based on the total dry weight of colloidal silica particles, synthetic polymer and/or polyaluminium chloride, and binder.

4. Method according to claim 1, characterised in using anionic colloidal silica.

5. Method according to claim 1, characterised in that the synthetic polymer is synthetic cationic polymer.

6. Method according to claim 5, characterised in that the charge density of the synthetic cationic polymer is 5 meq/g, typically 5-20 meq/g, preferably 5.5-8 meq/g, more preferably 5.5-6.5 meq/g.

7. Method according to claim 4, characterised in that the colloidal silica particles and the synthetic polymer have opposite charges.

8. Method according to claim 5, characterised in that the synthetic cationic polymer is selected from a group comprising cationic polyacrylamide, glyoxylated polyacrylamide, polyethyleneimine, polyamine, polyvinylamine, poly-diallyldimethylammonium chloride (poly-DADMAC), copolymer of acrylamide and diallyldimethylammonium chloride (DADMAC), polyamidoamine epihalohydrin and any of their mixtures.

9. Method according to claim 5, characterised in that the synthetic cationic polymer is cationic polyacrylamide, which is obtained by copolymerising acrylamide with a cationic monomer or methacrylamide with a cationic monomer selected from the group consisting methacryloyloxyethyltrimethyl ammonium chloride, acryloyloxyethyltrimethyl ammonium chloride, 3-(methacrylamido) propyltrimethyl ammonium chloride, 3-(acryloylamido) propyltrimethyl ammonium chloride, diallyldimethyl ammonium chloride, dimethylaminoethyl acrylate, dimethylaminoethyl methacrylate, dimethylaminopropylacrylamide, dimethylaminopropylmethacrylamide,

10. Method according to claim 1, characterised in that the synthetic polymer is obtained by polymerising cationic monomers within a coagulant matrix

11. Method according to claim 1, characterised in that the synthetic polymer has an average molecular weight of >100 000 Daltons, preferably 100 000-2 000 000 Daltons, more preferably 100 000-1 000 000 Daltons, still more preferably 120 000-200 000 Daltons.

12. Method according to claim 1, characterised in that the synthetic polymer is used in amount of 5-40 weight-%, preferably 7.5-35 weight-%, more preferably 10-30 weight-%, based on the total dry weight of colloidal silica particles, synthetic polymer, optional polyaluminium chloride, and binder.

13. Method according to claim 1, characterised in mixing together colloidal silica particles, an aqueous dispersion of polyaluminium chloride, as well as a binder solution.

14. Method according to claim 1, characterised in mixing together colloidal silica particles, an aqueous dispersion of a synthetic polymer and polyaluminium chloride, as well as a binder solution.

15. Method according to claim 1, characterised in using the binder in amount of 5-50 weight-%, preferably 7.5-25 weight-%, more preferably 10-50 weight-%, calculated from the total dry weight of colloidal silica particles, synthetic polymer and binder.

16. Method according to claim 1, characterised in that the binder comprises cationic starch solution.

17. Method according to claim 1, characterised in that the binder is selected from a group comprising polyvinyl alcohol, latex emulsion polymers, such as styrene acrylate latex, polyvinyl acetate latex, styrene butadiene latex, polyurethane, and polyacrylamides, and any of their mixtures.

18. Method according to claim 1, characterised in mixing water-soluble divalent metal salt, preferably an alkaline earth metal salt, such as calcium chloride, magnesium chloride, calcium formiate or magnesium formiate, to the coating composition.

19. Method according to claim 18, characterised in using divalent metal salt in amount of 2-25 weight-%, preferably 5-15 weight-%, more preferably 6-12 weight-%, based on the dry solids content of the coating composition.

20. Method according to claim 1, characterised in forming first a pre-mixture of colloidal silica particles and the aqueous dispersion of the synthetic polymer and/or polyaluminium chloride by mixing them together, and then combining the pre-mixture with the binder solution.

21. Coating composition, which is suitable for use in coating of a printing substrate, which coating composition is prepared according to claim 1, and comprises binder and a dispersed cationic component derived from synthetic polymer and/or polyaluminium chloride and colloidal silica particles.

22. Use of a coating composition according to claim 21 for coating of a sheet-like printing substrate with water-based inks.

23. Use of a coating composition according to claim 21 for coating of a sheet-like printing substrate for ink jet printing.

24. Use of a coating composition according to claim 21 for coating of a sheet-like printing substrate for flexogravure or rotogravure printing.

25. Use according to claim 22, characterised in that the amount of coating composition applied to at least one surface of the sheet-like printing substrate is 0.1-7 g/m²/side, preferably 0.2-5 g/m²/side, more preferably 0.3-3 g/m^{2/}side.
